(19) United States
(12) Patent Application Publication
(10) Pub. No.: US 2025/0196029 A1
(43) Pub. Date: Jun. 19, 2025

(54) CIRCULATING WATER PUMP FOR DATA CENTER COMPUTER ROOM

(71) Applicant: Hebei Qinhuai Data Co., Limited., Zhangjiakou City (CN)

(72) Inventor: Binghua ZHANG, Zhangjiakou City (CN)

(21) Appl. No.: 18/939,516

(22) Filed: Nov. 7, 2024

(30) Foreign Application Priority Data
Nov. 15, 2023 (CN) 202311526490.4

(51) Int. Cl. B01D 29/64; A46B 5/00; A46B 13/02; B01D 29/03; B01D 29/58; B01D 29/60; B01D 29/72; B01D 29/90; B01D 35/157; C02F 1/00; C02F 103/02

(52) U.S. Cl. CPC B01D 29/6415; A46B 5/0012; A46B 5/007; A46B 13/02; B01D 29/03; B01D 29/58; B01D 29/603; B01D 29/72; B01D 29/90; B01D 35/1573; C02F 1/001; A46B 2200/3073; C02F 2103/023; C02F 2201/005; C02F 2209/005; C02F 2209/40; C02F 2301/08; C02F 2303/16

(57) ABSTRACT

The present disclosure discloses a circulating water pump for a data center computer room, including a circulating water pump main body. A water inlet pipe and a water outlet pipe are respectively arranged on a left side and a right side below the circulating water pump main body. An end of the water inlet pipe is fixedly connected to a connecting pipe, on which there is provided with a cleaning pipe component I and a cleaning pipe component II having a same structure, and an electric butterfly valve is fixedly installed at an end of the cleaning pipe component I and of the cleaning pipe component II away from the water inlet pipe.

### CROSS REFERENCE TO RELATED APPLICATION

This application claims priority to Chinese Patent Application No. 202311526490.4, titled “CIRCULATING WATER PUMP FOR DATA CENTER COMPUTER ROOM” and filed to the China National Intellectual Property Administration on Nov. 15, 2023, the entire contents of which are incorporated herein by reference.

### TECHNICAL FIELD

The present disclosure relates to the field of circulating water pump technology, and more particularly, to a circulating water pump for a data center computer room.

### BACKGROUND

As places where data processors and servers are stored, data center computer rooms are internally provided with a large number of racks for placing electronic devices, which may keep generating heat during operation. When temperature inside the data center computer rooms is higher, normal operation of the electronic devices may be adversely affected, and in severe cases, burnout of the electronic devices may be caused. Therefore, heat dissipation of the data center computer rooms is particularly important. In commonly used methods, cooling towers are provided to water cooling units to dissipate heat. In summer, the water cooling units are turned on for refrigeration. In winter and transitional seasons, the cooling towers are directly used to dissipate the heat into air.

As core components in the water cooling units, circulating water pumps can circulate water in systems over and over again and overcome resistance loss of loop. This is a reason why they are called circulating water pumps. During operation of the circulating water pumps, some impurities that need to be removed may be generated inside pipelines due to problems of water quality or the pipelines themselves. Therefore, to extend service life of the circulating water pumps, generally apparatuses for removing the impurities may be arranged in the circulating water pumps. Filtering apparatuses in the existing circulating water pumps are simply filter plates. After the filter plates are used for a long time, their filtering holes may be blocked, causing decrease in pressure inside pipelines of water cooling systems and slowdown in cold water circulation speed, which may seriously have a negative effect on normal operation of the unit. Moreover, excessive impurities are adsorbed on the filter plates over time, causing serious blockage of the filter plates, which may increase load pressure of the circulating water pumps. However, the existing filter plates are generally installed at inlets of the circulating water pumps. When the filter plates are cleaned, it is required to shut down the circulating water pumps and then disassemble and clean the filter plates in the circulating water pumps, which is cumbersome in operation. Therefore, a circulating water pump for a data center computer room is proposed to solve the above problems.

### SUMMARY

In response to shortcomings of existing technologies, the present disclosure provides a circulating water pump for a data center computer room, which solves the problems raised in the background technology mentioned above.

To achieve the above objectives, the present disclosure is implemented through the following technical solutions. A circulating water pump for a data center computer room includes a circulating water pump main body. A water inlet pipe and a water outlet pipe are respectively arranged on a left side and a right side below the circulating water pump main body, where an end of the water inlet pipe is fixedly connected to a connecting pipe, on which there is provided with a cleaning pipe component I and a cleaning pipe component II having a same structure. An electric butterfly valve is fixedly installed at an end of the cleaning pipe component I and of the cleaning pipe component II away from the water inlet pipe. A cleaning component is arranged inside an end of the cleaning pipe component I and of the cleaning pipe component II close to the water inlet pipe. A blow off pipe positioned between the electric butterfly valve and the cleaning component is fixedly installed at a bottom of the cleaning pipe component I and of the cleaning pipe component II, and a bottom end of the blow off pipe is fixedly connected to a blowdown solenoid valve. The cleaning component includes a front-end filter plate, a rear-end filter plate, a transmission shaft, a transmission turbine, a rotary scrubbing mechanism, and a vibration cleaning mechanism. The transmission turbine is fixedly mounted on an outside of the transmission shaft. Number of the rotary scrubbing mechanisms and number of the vibration cleaning mechanisms are two, and the two rotary scrubbing mechanisms and the two vibration cleaning mechanisms correspond in position to the front-end filter plate and the rear-end filter plate, respectively: A flow meter is fixedly installed at an end of the connecting pipe close to the water inlet pipe, and a PLC controller is fixedly installed on the circulating water pump main body:

Preferably, a surface of the front-end filter plate and a surface of the back-end filter plate are both provided with a compact filter hole, where the filter hole on the front-end filter plate has a diameter of 0.5 to 1 mm, and the filter hole on the surface of the back-end filter plate has a diameter of 0.1 to 0.5 mm.

Preferably, a plate lug is provided on a periphery of the front-end filter plate and a periphery of the rear-end filter plate, inside the cleaning pipe component I and the cleaning pipe component II there is respectively provided with a locating slot fitting to the plate lug, a bolt is threaded through an inside of the plate lug, and the bolt is in threaded connection with the cleaning pipe component I and the cleaning pipe component II.

Preferably; the cleaning component also includes a mounting rack, which is clamped at an end of the cleaning pipe component I and of the cleaning pipe component II. The transmission shaft is movably sleeved in a middle of the mounting rack, and the transmission shaft is sleeved in a middle of the front-end filter plate and of the rear-end filter plate.

Preferably; the rotary scrubbing mechanism includes a central sleeve, a cleaning arm, a cleaning bristle, a locating ring, a compression spring, and a limit block. The central sleeve is movably sleeved on an outside of the transmission shaft, a plurality of cleaning arms are arranged on a periphery of the central sleeve, and one side of each of the plurality of cleaning arms is provided with the dense cleaning bristle.

Preferably; the locating ring is fixedly sleeved on the outside of the transmission shaft, the compression spring is movably sleeved on the outside of the transmission shaft, and the compression spring is positioned between the locating ring and the central sleeve. An inside of the central sleeve and the outside of the transmission shaft are provided with the limit block and a limit slot mutually matched.

Preferably, the vibration cleaning mechanism includes a locating cantilever, a guide rod, a top pressure rod, a drive slider, and a reset spring. The locating cantilever is fixedly connected to the plate lug of the front-end filter plate or rear-end filter plate by means of a bolt. An end of the locating cantilever is movably provided with the guide rod, which is fixedly connected to the top pressure rod. The reset spring is movably sleeved on an outside of the guide rod, the drive slider is fixedly installed on the outside of the transmission shaft, and the drive slider is provided with an oblique plane fitting to the top pressure rod.

Preferably; the reset spring is positioned on one side of the locating cantilever near the front-end filter plate or rear-end filter plate, and a cross-section of the guide rod is a polygon.

Preferably, the flow meter, the electric butterfly valve, and the blowdown solenoid valve are all electrically connected to a PLC controller. The PLC controller may control on/off of the electric butterfly valve and of the blowdown solenoid valve, and the PLC controller may also receive detection data of the blowdown solenoid valve.

The circulating water pump for the data center computer room provided by the present disclosure has the following beneficial effects.
1. In the circulating water pump for the data center computer room, two cleaning pipe components are provided to operate alternately, and a flow rate of cold water is detected by means of a flow meter. When the flow rate of the cold water decreases, this indicates that a filter plate in either of the two cleaning pipe components is blocked. In this case, the cleaning pipe in operation is turned off, and the other cleaning pipe is turned on. Besides, a blowdown solenoid valve on the blocked cleaning pipe is turned on. In this way, by means of back flush of the cold water, it is achieved automatic cleaning of the blocked filter plate without stopping the circulating water pump. Thus, the circulating water pump has a higher degree of automation.
2. In the circulating water pump for the data center computer room, when backwashing and cleaning the filter plate, the cold water drives the transmission turbine to drive the transmission shaft to rotate, thereby driving the rotary scrubbing mechanism to rotate and scrub the surface of the filter plate, which improves cleaning effects on the filter plate. Meanwhile, the compression spring applies an elastic force to the central sleeve and the cleaning arm, such that the cleaning bristle sticks close to the surface of the filter plate, to achieve deep cleaning of the filter hole on the filter plate, which can further improve the cleaning effects on the filter plate.
3. In the circulating water pump for the data center computer room, when the transmission turbine drives the transmission shaft to rotate, it synchronously drives the drive slider to rotate, thereby squeezing the top pressure rod and the guide rod to move. The top pressure rod is released when it moves to a tail end of the drive slider. At this moment, the reset spring applies an elastic force to the guide rod, causing the guide rod to collide with the filter plate, such that impurities on the filter plate are shaken off, which can further improve the cleaning effects on the filter plate.

### BRIEF DESCRIPTION OF THE DRAWINGS

FIG. 1 is a schematic structural diagram of a circulating water pump assembled according to the present disclosure;

FIG. 2 is a schematic structural diagram of a cleaning pipe component according to the present disclosure:

FIG. 3 is a schematic structural diagram of a cross-section of a cleaning pipe component I according to the present disclosure:

FIG. 4 is a schematic structural diagram of an outside of a transmission shaft according to the present disclosure;

FIG. 5 is a schematic structural diagram of a filter plate according to the present disclosure:

FIG. 6 is a schematic structural diagram of a vibration cleaning mechanism according to the present disclosure; and

FIG. 7 is a schematic structural diagram of a rotary scrubbing mechanism according to the present disclosure.

Reference numerals in the accompanying drawings: circulating water pump main body 1: water inlet pipe 2: water outlet pipe 3: connecting pipe 4: cleaning pipe component I 5: cleaning pipe component II 6; flow meter 7; electric butterfly valve 8; cleaning component 9: front-end filter plate 91: rear-end filter plate 92; transmission shaft 93; transmission turbine 94; rotary scrubbing mechanism 95; central sleeve 951; cleaning arm 952: cleaning bristle 953: locating ring 954: compression spring 955: limit block 956; vibration cleaning mechanism 96: locating cantilever 961: guide rod 962: top pressure rod 963: drive slider 964: reset spring 965: mounting rack 97: blow off pipe 10: blowdown solenoid valve 11; and PLC controller 12.

### DETAILED DESCRIPTION

Technical solutions in the embodiments of the present disclosure will be described clearly and completely below; in conjunction with the accompanying drawings in the embodiments of the present disclosure. Apparently, the described embodiments are some but not all of the embodiments of the present disclosure.

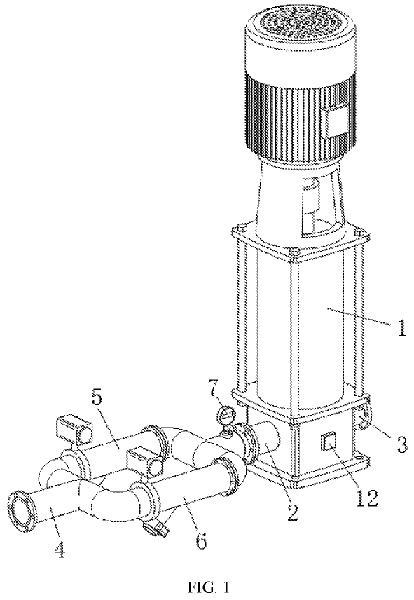

Referring to FIGS. 1, 2 and 3, the present disclosure provides a technical solution as below: A circulating water pump for a data center computer room includes a circulating water pump main body 1. A water inlet pipe 2 and a water outlet pipe 3 are respectively arranged on a left side and a right side below the circulating water pump main body 1, where an end of the water inlet pipe 2 is fixedly connected to a connecting pipe 4, on which there is provided with a cleaning pipe component I 5 and a cleaning pipe component II 6 having the same structure. An electric butterfly valve 8 is fixedly installed at an end of the cleaning pipe component I 5 and of the cleaning pipe component II 6 away from the water inlet pipe 2. A flow rate of cold water is detected by means of a flow meter 7. When the flow rate of the cold water decreases, this indicates that a filter plate in either of the two cleaning pipe components is blocked. In this case, the cleaning pipe in operation is turned off, and the other cleaning pipe is turned on. Besides, a blowdown solenoid valve 11 on the blocked cleaning pipe is turned on. In this way, by means of back flush of the cold water, it is achieved automatic cleaning of the blocked filter plate without stopping the circulating water pump. A cleaning component 9 is arranged inside an end of the cleaning pipe component I 5 and of the cleaning pipe component II 6 close to the water inlet pipe 2. A blow off pipe 10 positioned between the electric butterfly valve 8 and the cleaning component 9 is fixedly installed at a bottom of the cleaning pipe component I 5 and of the cleaning pipe component II 6, and a bottom end of the blow off pipe 10 is fixedly connected to a blowdown solenoid valve 11. When backwashing and cleaning the filter plate inside the cleaning pipe component I 5 or cleaning pipe component II 6, a PLC controller 12 can control the blowdown solenoid valve 11 to be turned on, such that sewage containing impurities is discharged along the blow off pipe 10 and the blowdown solenoid valve 11. The cleaning component 9 includes a front-end filter plate 91, a rear-end filter plate 92, a transmission shaft 93, a transmission turbine 94, a rotary scrubbing mechanism 95, and a vibration cleaning mechanism 96. Impurities in the cold water are filtered through the two filter plates with different filtering specifications to improve the filtering effects. The transmission turbine 94 is fixedly mounted on an outside of the transmission shaft 93. When backwashing and cleaning the filter plate, the cold water drives the transmission turbine 94 to drive the transmission shaft 93 to rotate, thereby driving the rotary scrubbing mechanism 95 to rotate and scrub the surface of the filter plate, which improves the cleaning effects on the filter plate. Number of the rotary scrubbing mechanisms 95 and number of the vibration cleaning mechanisms 96 are two, and the two rotary scrubbing mechanisms 95 and the two vibration cleaning mechanisms 96 correspond in position to the front-end filter plate 91 and the rear-end filter plate 92, respectively. When the transmission turbine 94 drives the transmission shaft 93 to rotate, it synchronously drives the drive slider 964 to rotate, thereby squeezing a top pressure rod 963 and a guide rod 962 to move. The top pressure rod 963 is released when it moves to an end of the drive slider 964. At this moment, the reset spring 965 applies an elastic force to the guide rod 962, causing the guide rod 962 to collide with the filter plate, such that impurities on the filter plate are shaken off. A flow meter 7 is fixedly installed at an end of the connecting pipe 4 close to the water inlet pipe 2, and a PLC controller 12 is fixedly installed on the circulating water pump main body 1. The PLC controller 12 can control on/off of the electric butterfly valve 8 and of the blowdown solenoid valve 11, and the PLC controller can control an operating state of the cleaning pipe component I 5 and of the cleaning pipe component II 6. The two cleaning pipe components can operate alternately: When one of the cleaning pipe components is operating, it can backwash and clean the filter plate in the other one of the cleaning pipe components.

Referring to FIGS. 3, 4 and 5, a surface of the front-end filter plate 91 and a surface of the back-end filter plate 92 are both provided with compact filter holes. The impurities in the cold water are filtered through the filter holes on the front-end filter plate 91 and the back-end filter plate 92, to prevent excessive impurities from adversely affecting the operation of a water cooling system and a water pump. The filter hole on the front-end filter plate 91 has a diameter of 0.5 to 1 mm, and the filter hole on the surface of the back-end filter plate 92 has a diameter of 0.1 to 0.5 mm. The impurities in the cold water are filtered through the two filter plates with different filtering specifications to improve the filtering effects. A plate lug is provided on a periphery of the front-end filter plate 91 and a periphery of the rear-end filter plate 92. Inside the cleaning pipe component I 5 and the cleaning pipe component II 6 there is respectively provided with a locating slot fitting to the plate lug, which can achieve preliminary positioning of the front-end filter plate 91 and the rear-end filter plate 92, thereby ensuring stability of the front-end filter plate 91 and the rear-end filter plate 92 during operation. A bolt is threaded through an inside of the plate lug, and the bolt is in threaded connection with the cleaning pipe component I 5 and the cleaning pipe component II 6. The front-end filter plate 91 and the rear-end filter plate 92 are fixedly installed on the cleaning pipe component I 5 and the cleaning pipe component II 6 through the bolt, to ensure the stability of the front-end filter plate 91 and the rear-end filter plate 92 during operation.

Referring to FIGS. 3 and 5, the cleaning component 9 also includes a mounting rack 97, which is clamped at an end of the cleaning pipe component I 5 and of the cleaning pipe component II 6. A position of the transmission shaft 93 is limited by means of the mounting rack 97 to ensure stability of the transmission shaft 93 during rotation. The transmission shaft 93 is movably sleeved in a middle of the mounting rack 97, and the transmission shaft 93 is sleeved in a middle of the front-end filter plate 91 or rear-end filter plate 92. When backwashing and cleaning the front-end filter plate 91 or rear-end filter plate 92, the cold water may drive the transmission turbine 94 to rotate, thereby driving the transmission shaft 93 and the rotary scrubbing mechanism 95 to rotate, thereby achieving efficient cleaning of the filter plate.

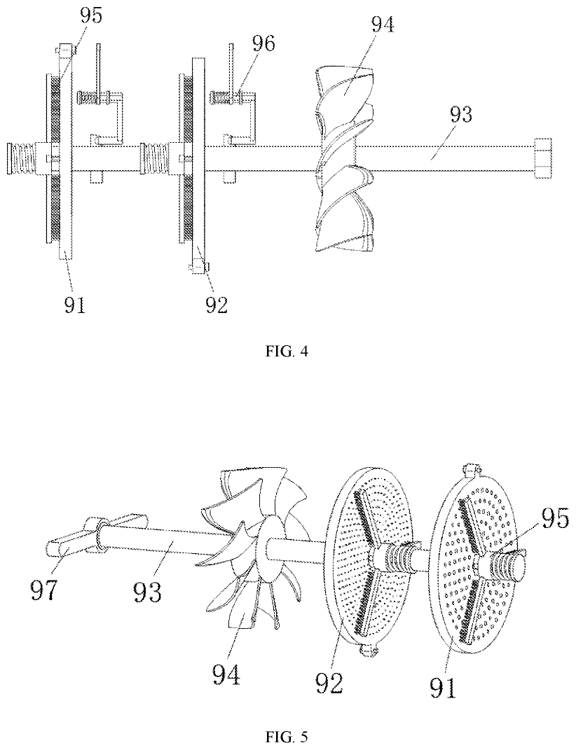

Referring to FIGS. 4 and 7, the rotary scrubbing mechanism 95 includes a central sleeve 951, a cleaning arm 952, a cleaning bristle 953, a locating ring 954, a compression spring 955, and a limit block 956. The central sleeve 951 is movably sleeved on an outside of the transmission shaft 93. When the transmission shaft 93 rotates, the central sleeve 951 can be driven to rotate synchronously, thereby driving the cleaning arm 952 and the cleaning bristle 953 to rotate and clean impurities on the surface of the filter plate. A plurality of cleaning arms 952 are arranged on a periphery of the central sleeve 951, and one side of each of the plurality of cleaning arms 952 is provided with the dense cleaning bristle 953. When backwashing and cleaning the filter plate, the cold water drives the transmission turbine 94 to drive the transmission shaft 93 to rotate, thereby driving the rotary scrubbing mechanism 95 to rotate and scrub the surface of the filter plate, which improves the cleaning effects on the filter plate. The locating ring 954 is fixedly sleeved on the outside of the transmission shaft 93, the compression spring 955 is movably sleeved on the outside of the transmission shaft 93, and the compression spring 955 is positioned between the locating ring 954 and the central sleeve 951. Meanwhile, the compression spring 955 applies an elastic force to the central sleeve 951 and the cleaning arm 952, such that the cleaning bristle 953 sticks close to the surface of the filter plate, to achieve deep cleaning of the filter hole on the filter plate. An inside of the central sleeve 951 and the outside of the transmission shaft 93 are provided with the limit block 956 and a limit slot mutually matched. The central sleeve 951 is restricted by means of the limit block 956 and the limit slot, such that the central sleeve 951 can slide outside the transmission shaft 93 under the elastic force of the compression spring 955, while ensuring that the transmission shaft 93 can drive the central sleeve 951 to rotate.

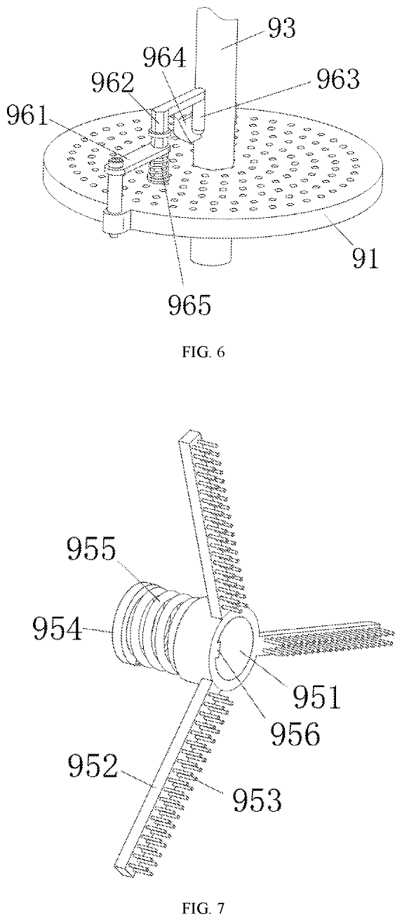

Referring to FIGS. 4 and 6, the vibration cleaning mechanism 96 includes a locating cantilever 961, a guide rod 962, a top pressure rod 963, a drive slider 964, and a reset spring 965. The locating cantilever 961 is fixedly connected to the plate lug of the front-end filter plate 91 or rear-end filter plate 92 by means of a bolt, and the locating cantilever 961 is fixed inside the cleaning pipe component I 5 or cleaning pipe component II 6 by means of the bolt, to ensure overall stability of the vibration cleaning mechanism 96 during operation. An end of the locating cantilever 961 is movably provided with the guide rod 962 fixedly connected to the top pressure rod 963, where the guide rod 962 and the top pressure rod 963 have an integrated structure to achieve synchronous movement. The reset spring 965 is movably sleeved on an outside of the guide rod 962, and the drive slider 964 is fixedly installed on the outside of the transmission shaft 93. When the transmission shaft 93 rotates, it synchronously drives the drive slider 964 to rotate, thereby squeezing the top pressure rod 963 and the guide rod 962 to move. The top pressure rod 963 is released when it moves to an end of the drive slider 964. At this moment, the reset spring 965 applies an elastic force to the guide rod 962, causing the guide rod 962 to collide with the filter plate, such that the impurities on the filter plate are shaken off. The drive slider 964 is provided with an oblique plane fitting to the top pressure rod 963. By providing the oblique plane, it is ensured that the drive slider 964 can squeeze the top pressure rod 963 to move, thereby driving the guide rod 962 to move, and achieving subsequent vibration cleaning of the filter plate. The reset spring 965 is positioned on one side of the locating cantilever 961 near the front-end filter plate 91 or rear-end filter plate 92, and a cross-section of the guide rod 962 is a polygon. In this way, the guide rod 962 is prevented from rotating along an axis, such that the guide rod 962 can only slide at the end of the locating cantilever 961, thereby ensuring that the top pressure rod 963 can precisely match up with the drive slider 964.

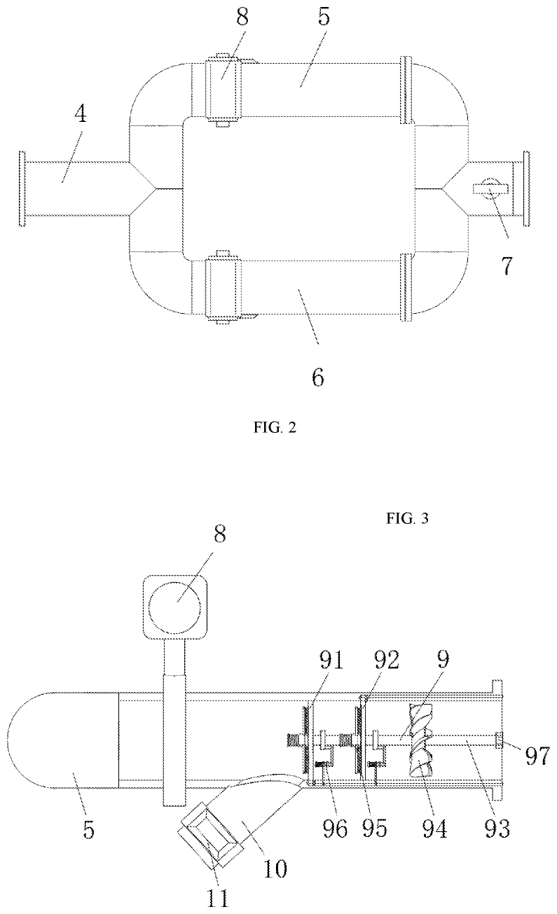

Referring to FIGS. 2 and 3, the flow meter 7, the electric butterfly valve 8, and the blowdown solenoid valve 11 are all electrically connected to the PLC controller 12. The PLC controller 12 can control on/off of the electric butterfly valve 8 and of the blowdown solenoid valve 11, and the PLC controller 12 can receive detection data of the blowdown solenoid valve 11. Besides, based on the detection data of the blowdown solenoid valve 11, the PLC controller 12 can control the electric butterfly valve 8 and the blowdown solenoid valve 11 on the cleaning pipe component I 5 or cleaning pipe component II 6, thereby controlling on/off of the cleaning pipe component I 5 or cleaning pipe component II 6, to backwash and clean the filter plate inside the cleaning pipe component I 5 or cleaning pipe component II 6.

In summary, when the circulating water pump for the data center computer room is in use, the electric butterfly valve 8 and the blowdown solenoid valve 11 on the cleaning pipe component I 5 or cleaning pipe component II 6 and the flow meter 7 are electrically connected to the PLC controller 12. The cleaning pipe component I 5 and the cleaning pipe component II 6 operate alternately: When the cleaning pipe component I 5 is operating, the electric butterfly valve 8 on the cleaning pipe component I 5 is turned on, and the blowdown solenoid valve 11 is turned off. In this case, both the electric butterfly valve 8 and the blowdown solenoid valve 11 on the cleaning pipe component II 6 are turned off. The cold water enters the cleaning pipe component I 5 along an inlet end of the connecting pipe 4 and finally enters the circulating water pump main body 1. The impurities in the cold water are filtered by means of the front-end filter plate 91 and the rear-end filter plate 92 in the cleaning pipe component I 5. The flow rate of the cold water is detected by means of the flow meter 7, and the detection data are transmitted to the PLC controller 12. When the flow rate of the cold water decreases to a set value, this indicates that the front-end filter plate 91 and/or the rear-end filter plate 92 in the cleaning pipe component I 5 are blocked. In this case, the PLC controller 12 controls the electric butterfly valve 8 on the cleaning pipe component II 6 to be turned on, and controls the electric butterfly valve 8 on the cleaning pipe component I 5 to be turned off. In this case, the cleaning pipe component II 6 intervenes in the operation. Meanwhile, the PLC controller 12 controls the blowdown solenoid valve 11 on the cleaning pipe component I 5 to be on for 5 to 20 s. The cold water enters the cleaning pipe component I 5 along a tail end of the cleaning pipe component I 5, backwashes the front-end filter plate 91 and the rear-end filter plate 92 in the cleaning pipe component I 5, and discharges the cold water containing the impurities along the blow off pipe 10. When the cold water backwashes in the cleaning pipe component I 5, the transmission turbine 94 is driven to rotate, thereby driving the transmission shaft 93 and two rotary scrubbing mechanisms 95 to rotate, to clean the impurities on the surface of the front-end filter plate 91 and the rear-end filter plate 92. The compression spring 955 applies the elastic force to the central sleeve 951 and the cleaning arm 952, such that the cleaning bristle 953 sticks close to the filter plate, which can improve the cleaning effects. Meanwhile, when the transmission shaft 93 rotates, the drive slider 964 is driven to rotate, thereby squeezing the top pressure rod 963 and the guide rod 962 to move. The top pressure rod 963 is released when it moves to a tail end of the drive slider 964. At this moment, the reset spring 965 applies an elastic force to the guide rod 962, causing the guide rod 962 to collide with the filter plate, such that the impurities on the filter plate are shaken off. In this way, efficient cleaning of the impurities on the surface of the front-end filter plate 91 and/or the rear-end filter plate 92 in the cleaning pipe component I 5 is completed. When the front-end filter plate 91 and/or the rear-end filter plate 92 in the cleaning pipe component II 6 are blocked, the impurities are removed in this way.

In the description of the present disclosure, it is to be noted that the orientation or position relations represented by the terms “center”, “above”, “beneath”, “left”, “right”, “vertical”, “horizontal”, “inside”, “outside” and the like are orientation or position relations shown based on the accompanying figures, they are merely for ease of a description of the present disclosure and a simplified description instead of being intended to indicate or imply the apparatus or element to have a special orientation or to be configured and operated in a special orientation. Thus, they cannot be understood as limiting of the present disclosure. Terms such as “first”, “second” and “third” are used only for purposes of description and are not intended to indicate or imply relative importance. In addition, it is to be noted that unless explicitly specified or limited otherwise, terms “installation”, “connecting” or “connection” should be understood in a broad sense, which may be, for example, a fixed connection, a detachable connection or integrated connection, a mechanical connection or an electrical connection, a direct connection or indirect connection by means of an intermediary, or an internal communication between two components. For those of ordinary skill in the art, specific meanings of the above terms in the present disclosure may be understood based on specific circumstances. Furthermore, terms such as “comprise”, “include” or other variants thereof are intended to cover a non-exclusive “include” such that a process, a method, a merchandise or a device comprising a series of elements not only includes these elements, but also includes other elements not listed explicitly, or also includes inherent elements of the process, the method, the merchandise or the device.

Although the embodiments of the present disclosure have been illustrated and described, those of ordinary skill in the art may appreciate that various changes, modifications, substitutions and variations may be made to these embodiments without departing from the principle or spirit of the present disclosure, and the scope of the present disclosure is limited by the claims and equivalents thereof.

What is claimed is:

1. A circulating water pump for a data center computer room, comprising a circulating water pump main body (1), a water inlet pipe (2) and a water outlet pipe (3) being respectively arranged on a left side and a right side below the circulating water pump main body (1), wherein an end of the water inlet pipe (2) is fixedly connected to a connecting pipe (4), a cleaning pipe component I (5) and a cleaning pipe component II (6) are arranged on the connecting pipe (4), the cleaning pipe component I (5) and the cleaning pipe component II (6) have a same structure, an electric butterfly valve (8) is fixedly installed at an end of the cleaning pipe component I (5) and of the cleaning pipe component II (6) away from the water inlet pipe (2), a cleaning component (9) is arranged inside an end of the cleaning pipe component I (5) and of the cleaning pipe component II (6) close to the water inlet pipe (2), a blow off pipe (10) positioned between the electric butterfly valve (8) and the cleaning component (9) is fixedly installed at a bottom of the cleaning pipe component I (5) and of the cleaning pipe component II (6), and a bottom end of the blow off pipe (10) is fixedly connected to a blowdown solenoid valve (11): the cleaning component (9) comprises a front-end filter plate (91), a rear-end filter plate (92), a transmission shaft (93), a transmission turbine (94), a rotary scrubbing mechanism (95), and a vibration cleaning mechanism (96): the transmission turbine (94) is fixedly mounted on an outside of the transmission shaft (93): number of the rotary scrubbing mechanisms (95) and number of the vibration cleaning mechanisms (96) are two, and the two rotary scrubbing mechanisms (95) and the two vibration cleaning mechanisms (96) correspond in position to the front-end filter plate (91) and the rear-end filter plate (92), respectively; and a flow meter (7) is fixedly installed at an end of the connecting pipe (4) close to the water inlet pipe (2), and a PLC controller (12) is fixedly installed on the circulating water pump main body (1).

2. The circulating water pump for the data center computer room according to claim 1, wherein a surface of the front-end filter plate (91) and a surface of the back-end filter plate (92) are both provided with a compact filter hole, the filter hole on the front-end filter plate (91) has a diameter of 0.5 to 1 mm, and the filter hole on the surface of the back-end filter plate (92) has a diameter of 0.1 to 0.5 mm.

3. The circulating water pump for the data center computer room according to claim 2, wherein a plate lug is provided on a periphery of the front-end filter plate (91) and a periphery of the rear-end filter plate (92), inside the cleaning pipe component I (5) and the cleaning pipe component II (6) there is respectively provided with a locating slot fitting to the plate lug, a bolt is threaded through an inside of the plate lug, and the bolt is in threaded connection with the cleaning pipe component I (5) and the cleaning pipe component II (6).

4. The circulating water pump for the data center computer room according to claim 3, wherein the cleaning component (9) further comprises a mounting rack (97), the mounting rack (97) is clamped at an end of the cleaning pipe component I (5) and of the cleaning pipe component II (6), the transmission shaft (93) is movably sleeved in a middle of the mounting rack (97), and the transmission shaft (93) is sleeved in a middle of the front-end filter plate (91) and of the rear-end filter plate (92).

5. The circulating water pump for the data center computer room according to claim 4, wherein the rotary scrubbing mechanism (95) comprises a central sleeve (951), a cleaning arm (952), a cleaning bristle (953), a locating ring (954), a compression spring (955), and a limit block (956): the central sleeve (951) is movably sleeved on an outside of the transmission shaft (93), a plurality of cleaning arms (952) are arranged on a periphery of the central sleeve (951), and one side of each of the plurality of cleaning arms (952) is provided with the dense cleaning bristle (953).

6. The circulating water pump for the data center computer room according to claim 5, wherein the locating ring (954) is fixedly sleeved on the outside of the transmission shaft (93), the compression spring (955) is movably sleeved on the outside of the transmission shaft (93), and the compression spring (955) is positioned between the locating ring (954) and the central sleeve (951), and an inside of the central sleeve (951) and the outside of the transmission shaft (93) are provided with the limit block (956) and a limit slot mutually matched.

7. The circulating water pump for the data center computer room according to claim 6, wherein the vibration cleaning mechanism (96) comprises a locating cantilever (961), a guide rod (962), a top pressure rod (963), a drive slider (964), and a reset spring (965): the locating cantilever (961) is fixedly connected to the plate lug of the front-end filter plate (91) or rear-end filter plate (92) by means of a bolt, an end of the locating cantilever (961) is movably provided with the guide rod (962) fixedly connected to the top pressure rod (963), the reset spring (965) is movably sleeved on an outside of the guide rod (962), the drive slider (964) is fixedly installed on the outside of the transmission shaft (93), and the drive slider (964) is provided with an oblique plane fitting to the top pressure rod (963).

8. The circulating water pump for the data center computer room according to claim 7, wherein the reset spring (965) is positioned on one side of the locating cantilever (961) near the front-end filter plate (91) or rear-end filter plate (92), and a cross-section of the guide rod (962) is a polygon.

9. The circulating water pump for the data center computer room according to claim 8, wherein the flow meter (7), the electric butterfly valve (8), and the blowdown solenoid valve (11) are all electrically connected to a PLC controller (12), the PLC controller (12) is configured to control on/off of the electric butterfly valve (8) and of the blowdown solenoid valve (11), and the PLC controller (12) is further configured to receive detection data of the blowdown solenoid valve (11).
